(19) United States
(12) Patent Application Publication
(10) Pub. No.: US 2017/0323062 A1
(43) Pub. Date: Nov. 9, 2017

(54) USER GUIDANCE SYSTEM AND METHOD, USE OF AN AUGMENTED REALITY DEVICE

(71) Applicant: KONINKLIJKE PHILIPS N.V., EINDHOVEN (NL)

(72) Inventors: JOHAN PARTOMO DJAJADININGRAT, UTRECHT (NL); PEI-YIN CHAO, EINDHOVEN (NL); JOZEF HIERONYMUS MARIA RAIJMAKERS, EINDHOVEN (NL)

(73) Assignee: Koninklijke Philips N.V., Eindhoven (NL)

(21) Appl. No.: 15/526,577

(22) PCT Filed: Nov. 5, 2015
(86) PCT No.: PCT/EP2015/075762

§ 371 Date: May 12, 2017

(30) Foreign Application Priority Data
Nov. 18, 2014 (EP) 14193597.3

(51) Int. Cl. G06F 19/00; G06F 17/30; G06T 19/00; G02B 27/01

(52) U.S. Cl. CPC G06F 19/34; G06T 19/006; G02B 27/017; G06F 17/30648; G02B 2027/0178

(57) ABSTRACT

The present disclosure relates to an augmented reality based user guidance system for multi-step medical procedures, the system comprising an augmented reality device (10, 30) comprising a display unit (14, 34) arranged to present artificial information that can be overlaid on an original scene, a sensor unit (18, 38), a processing unit (22, 42), at least one first marker (142, 144, 146, 148) that can be detected by the augmented reality device (10, 30), wherein the at least one first marker (142, 144, 146, 148) is associated with an object (132, 134, 136, 138) to be used in a defined step of the medical procedure, wherein the medical procedure comprises at least one step that requires a user action, wherein the augmented reality device (10, 30) is arranged to monitor a scene and to detect and track the at least one first marker (142, 144, 146, 148), provide user guidance to execute the medical procedure, detect whether user actions comply with the medical procedure, based on a detected state of the at least one first marker (142, 144, 146, 148), and when the augmented reality device (10, 30) detects an erroneous user action, provide corrective user feedback to the user. The disclosure further relates to a corresponding method and to a use of an augmented reality device (10, 30) in a system for user guidance.

### FIELD OF THE INVENTION

The present disclosure relates to an augmented reality based user guidance system for multi-step medical procedures, and to a corresponding method. The present disclosure further relates to a use of an augmented reality device in a system for user guidance in a medical procedure. The present disclosure further relates to a corresponding computer program.

### BACKGROUND OF THE INVENTION

US 2012/0184252 A1 discloses a mobile phone type electronic device, the device comprising a display; processor resources; at least one computer readable media, capable of receiving and storing information, in communication with the processor resources; instructions on the media, that when executed by the processor resources are operative to calculate and display supplemental information on a visual representation of an object shown at the display. Similar augmented reality devices, particularly head mounted devices, are known from US 2011/0213664 A1, U.S. Pat. No. 8,705,177 B1, and US 2013/0278485 A1, for instance. Generally, augmented reality devices may be referred to as wearable devices, and may involve hand-held devices, optical head-mounted displays, etc.

Augmented reality (AR) may be referred to as a live direct or indirect view of a physical, real-world environment whose elements may be augmented (or, in other words, supplemented) by computer-generated sensory input such as sound, video, graphics or GPS data. Put differently, layers containing artificial-information may be superimposed to a representation of layers containing real-world information. Generally, augmented information may be visually presented to a user that observes a real-life scene, either directly or in a mediate way. However, also audio information, speech information, tactile information, etc. may be overlaid on a real-world perception in an augmented reality environment.

In a general sense, augmented reality may relate to a more general concept that may be referred to as mediated reality. Mediated reality generally involves that a representation or view of reality is modified by computing devices. Modifications in this context may involve emphasizing, diminishing, or even hiding real-world information elements.

Augmented reality devices may therefore influence, preferably enhance, a user's current perception of reality. Generally, augmented reality involves real-time or nearly real-time augmentation or superimposition of information.

A medical procedure is a course of action intended to achieve a result in the care of persons that may potentially have health issues or even health problems. Generally, medical procedures may involve medical tests, medical monitoring, medical treatment, medical therapy, rehabilitation measures, etc. Medical tests are generally conducted with the intention of determining, measuring or diagnosing a patient condition or parameter. Therapeutic measures typically involve treating, curing or restoring functions or structures of a patient.

There is still room for improvement in the field of augmented reality. More particularly, there is a certain application potential of augmented reality based technology in the medical field or, more generally, the field or user guidance or patient guidance.

### SUMMARY OF THE INVENTION

In view of the above, it is an object of the present invention to provide an enhanced augmented reality based user guidance system for multi-step medical procedures that may guide a user in the course of a medical procedure and that is particularly suited for amateur users or laypersons that are not necessarily professionally qualified to perform and accomplish relatively complex medical procedures and/or medical protocols.

Further, it would be beneficial to provide an enhanced augmented reality based user guidance system that facilitates home user treatment and/or outpatient treatment. It would be further advantageous to provide a respective system that enables enhanced user guidance and that can take even further advantage of augmented reality techniques.

Further, it would be beneficial to provide a corresponding augmented reality based user guidance method for multi-step medical procedures, and a preferred use of an augmented reality device in a system for user guidance in a medical procedure. Preferably, also a corresponding computer program is presented.

In a first aspect of the present invention an augmented reality based user guidance system for multi-step medical procedures is presented, the system comprising:
an augmented reality device comprising:
   a display unit arranged to present artificial information that can be overlaid on an original scene,
   a sensor unit,
   a processing unit,
at least one first marker that can be detected by the augmented reality device, wherein the at least one first marker is associated with an object to be used in a defined step of the medical procedure, wherein the medical procedure comprises at least one step that requires a user action, particularly involving manually handling the object,
wherein the augmented reality device is arranged to
   monitor a scene and to detect and track the at least one first marker,
   provide user guidance to execute the medical procedure,
   detect whether user actions comply with the medical procedure, based on a detected state of the at least one first marker, and
   when the device detects an erroneous user action, provide corrective user feedback to the user.

This aspect is based on the insight that relatively complex medical procedures (which may also be referred to as medical protocols) typically require experienced educated medical staff. However, there is a certain trend to redeploy medical service from hospitals to a patient's home. This may have the advantage of reduced costs and an increased well-being of the patients that may stay in their familiar environment. However, there is often still a need to execute relatively complex medical procedures, e.g. blood sampling, blood sugar measurement, etc., often repeatedly (once per day, once per week, etc.).

In conventional environments this requires extensive training of the patient or relatives/friends that take care of the patient. Even when excessive training is conducted, there is still the risk of faulty operations which might harm the patient or the outcome of the medical procedure. Hence, particularly for elderly people, it might be required to send a nurse of other qualified staff to the patient's place, or even to keep the patient in a hospital environment.

A further significant benefit may be seen in the system's ability to assist low-qualified or inexperienced staff when exercising tasks in the medical domain. Hence, the augmented reality based user guidance system may be utilized by medical trainees, such as nurse trainees, etc. Further application can be found in connection with the delegation of tasks from high-qualified professionals to low-qualified staff so as to relieve the professionals from rather ordinary tasks in the medical domain. Quite often medical facilities face a shortage of high-qualified medical practitioners and nurses. So the augmented reality based user guidance system may facilitate maintaining quality standards even in the event of qualified-staff shortages.

As used herein, the augmented reality (AR) based user guidance system generally may be referred to as AR supported and/or AR enhanced system. The AR based user guidance system may be helpful in self-treatment environments (e.g. conducted by the patient itself) but also in environments that include users (assisting staff) that treat a patient.

With the help of advanced AR technology (e.g. adding computer vision and object recognition to a real-life representation) the information about the surrounding real world of the user becomes interactive and digitally manipulable. Artificial information about the environment and its objects can be overlaid on the real world. This may have the advantage that an interactive instructive manual can be provided that may be further enhanced in that corrective user feedback may be presented. Generally, positive feedback (i.e. a procedure or a sub-step thereof has been successfully accomplished) may be provided. Further, in case an error occurs, the system may work towards a successful completion of the intended procedure.

Particularly in so-called hospital at home environments (also referred to as hospital to home (H2H) environments) patients are increasingly asked to run through relatively complex medical protocol themselves, without assistance by professional medical staff. Typically the medical protocol may include actions in the physical world using a plurality of separate physical devices and consumables. For example, chemotherapy patients doing blood analysis may have to use a lancet, an alcohol swab, a band-aid and a blood cartridge in a particular order and fashion. Handling the at least one object may include moving, particularly manually moving the object. Handling the object may further include unwrapping or unpacking the object. At least some of the objects to be used in the course of the medical procedure may be initially contained in a sterile goods packing. Hence, handling the at least one object may further include rupturing a sterile container or bag.

A plurality of objects may be provided. The object(s) may comprise a (pharmaceutical) drug, substance or medicine. Further, the object may comprise a medical appliance, particularly a disposable medical appliance. Medical appliances may comprise a lancet, a syringe, a thermometer, a blood pressure apparatus, a vial, etc. In addition, or in the alternative, the object(s) may comprise further material/equipment that is typically used in medical procedures. By way of example, medical materials may include (surgical) dressing material, (surgical) swabs, (surgical) tabs, adhesive bandages, patches, sanitizers, antiseptic agents, disinfecting agents, etc.

Generally, the at least one first marker may be attached to the to-be-used object, and/or may be attached to a respective container or packaging containing the object. The at least one first marker may contain information that describes the type of the object. Further, the at least one first marker may contain information that indicates a serial number, a production lot, a production term, etc. of the particular object. The object may be labelled with the at least one marker. The at least one marker may be arranged as a tag or label that is attached to the object or to the object's packing.

However, the above aspect is not limited to hospital at home applications. By way of example, in emergency care (e.g. patients suffering heart attacks, first aid in the aftermath of road accidents), first aiders may have to apply hygiene masks to the face of injured, unconscious persons, defibrillation patches to the chest, and to place their hands correctly and run through a strict sequence of actions. Further applications may be envisaged in which even relatively skilled, educated medical professionals may profit from AR based guidance systems.

The AR device may be arranged as a wearable computing device, e.g. a portable device, hand held device, head mounted device, etc. Generally, the AR device may comprise a display that is arranged to overlay information on a real-life representation. The real-life representation may be directly or indirectly perceivable for the user. An indirectly presented real-life image may be captured and (more or less) instantly represented at a display. Preferably, a respective sensor (imaging unit, or, camera) and the display unit are (physically or virtually) aligned such that the representation of the real-life image basically matches the “real” real-life environment when the user looks at the display of the device. In the alternative, the real-life environment that is directly perceivable to the user's eye may be enriched or enhanced by supplemental information. This may involve that potential display elements provided at the display unit are basically transparent or translucent. Such a display unit may be arranged as a so-called micro display which includes means for projecting image date in a user's field of view. As indicated above, the user may be the patient himself/herself or another person that helps and/or treats the patient in the course of the medical procedure. Hence, in some embodiments, the AR device is worn by the patient. In some embodiments, the AR device is held or worn by another person.

In an exemplary embodiment of the system, a least one second marker is provided that is arranged at a location assigned to a defined step of the medical procedure, wherein the medical procedure comprises at least one step that requires placing the object, particularly the at least one first marker thereof, in the vicinity of the second marker to accomplish a step of the medical procedure.

Consequently, the AR device may control the progress of the medical procedure by monitoring and tracking the position of the at least one first marker with respect to the second marker. By way of example, a board or a similar base element may be provided at which the at least one second marker is arranged. Further, the base element may visually indicate the required steps of the medical procedure. The AR device may then highlight the currently to-be-used first marker and the corresponding second marker. The AR device may be arranged to detect whether the first marker is arranged close to, on top of, or at the second marker. This may be regarded as an indication that a (sub-)step of the medical procedure is accomplished. The AR device may be arranged to detect a (local) match of the first marker and the corresponding second marker. The AR device may be arranged to detect whether the first marker is congruent, coincident and/or in registry with the corresponding second marker. This may involve that an error message is generated when the AR device detects that the first marker is poorly placed, for instance at the wrong second marker and/or wherein the distance between the first marker and the corresponding second marker is too great.

In another exemplary embodiment of the system, the at least one first marker is arranged as a cover marker, wherein the at least one second marker is arranged as a base marker, and wherein the at least one first marker is attached to a disposable object or a consumable object, particularly to a packing or to a tamper-proof element thereof. By way of example, the use may be instructed to remove a seal, open a lid and/or to rupture a package. Accordingly, the respective first marker may be arranged at the portion of the object or its packaging that is to be removed when unpacking, opening and/or activating the object.

In other words, augmented reality markers may be arranged both at basically stationary elements (frame, board, portion of outer packaging, etc.) and at movable, separate physical objects. The AR device may track (spatial) 2D or 3D coordinates of physical objects, including the stationary elements that are in the field of view of a respective sensor unit, e.g. a camera. Further, an algorithm describing the medical procedure and/or protocol may be implemented in software code and provided at the AR device. Consequently, the AR device “knows” which objects should be where at what time. Since, because of their markers, the objects are traceable, the AR device is capable of detecting when a user is handling the wrong object or when the user puts the right object in the wrong place. Consequently, when the user looks at the physical scene using augmented reality technology (e.g. through a mobile phone, tablet computer or an AR headset), the AR device may point directly at the object being handled and show and tell the user that this is the wrong place, or object. Further, corrective actions can be recommended to the user, e.g. that he/she should pick up another object or that he/she should put the object at a different location.

In this context, reference is made to US 2007/0098234 A1 which discloses a variety of different AR markers and corresponding methods for detecting said markers. Generally, AR markers may be arranged in a paper-based or film-based fashion, wherein a 2D code printed thereon is relatively simple and easy to detect and to use. Generally, AR markers may be visually perceivable for a sensor, e.g. a camera. AR markers may be coded, e.g. bar coded, or, more generally, may comprise 1D or 2D optical machine-readable representations. AR markers may be arranged as tags, labels, for instance. Furthermore, AR markers may comprise multi-digit information, e.g. Universal Product Code (UPC) and/or International Article Number Code (EAN). At least some embodiments may include the detection of 3D (tree-dimensional) markers. Further, some embodiments may include object recognition and tracking without the explicit need of attaching distinct tags or labels to the objects. Consequently, the object itself may form the marker, e.g. the object's outer shape, color or outer print.

However, also invisible coding marker technologies may be envisaged. By way of example, AR markers may include radio-frequency identification tags (RDIF tags). Further, AR markers may be arranged as transponders. Depending on the type of the AR marker (e.g., passive or active), respective sensors (readers) may be utilized. Further, different types of AR markers may me implemented and utilized in a respective AR assisted/supported environment.

In another exemplary embodiment of the system, the at least one first marker is a non-stationary marker that is attached to an object that is to be moved in the course of the medical procedure, wherein the at least one second marker is a stationary marker that indicates a characteristic location at medical equipment that is subject of the medical procedure, and wherein the system is capable of detecting a state in which at least one non-stationary marker approaches a respective stationary marker to fulfil a step of the medical procedure. The stationary marker indicates a characteristic location that needs to be approached in the course of the medical procedure.

Generally, augmented reality applications allow the user to perceive virtual content as an overlay on top of a representation of physical objects. The virtual content may be automatically shown when a sensor (e.g. a camera) detects a respective marker. Generally, augmented reality markers are applied as information cues and are therefore not very frequently used as positional sensors. By contrast, the current disclosure proposes to enhance the application and capability of augmented reality markers by defining several types of markers, and by tracking positions of the markers so as to detect relative positions between pairs of markers of different types which may be used as a relatively simple but powerful means for monitoring medical procedures, and for providing enhanced user guidance for medical procedures.

Preferably, the system is further arranged to provide navigation support to the user, particularly by tracking the at least one movable marker in the course of approaching the respective stationary marker. In other words, the AR device may display information and hints (e.g., a light beam or landing beam) that indicate the correct target position (stationary marker) for the currently used object and/or its respective marker.

For instance, a base board may be provided that illustrates steps of the medical procedure in a visually perceivable manner, i.e. directly visible to the user's eye. To this end, a respective flow chart may be provided, for instance. So, in the real-world environment, the user may be (visually) prompted to place the corresponding cover markers close to or at their designated counterparts. However, the real-world flow chart may be enhanced by the provision of respective base markers that indicate steps or gates of the medical procedure and can be virtually highlighted. Hence, in the combined augmented reality environment, the user may be prompted and guided even more explicitly. Further, the augmented reality environment may provide visual feedback, audio feedback, etc. to the user so as to indicate whether a (sub-)step has been accomplished successfully or whether an error occurred. In case of an error, the AR device may instantly or nearly instantly recommend corrective action. This may have the advantage that quite often the overall medical procedure can be accomplished successfully, i.e. in case of an error, it is not necessarily required to repeat the whole procedure.

In still another exemplary embodiment of the system, the augmented reality device is arranged to indicate a subsequent step by virtually highlighting at least one marker associated with the subsequent step. Furthermore, the AR device may be arranged to navigate the user by providing directional information in the course of approaching the base marker with the cover marker.

In still another exemplary embodiment of the system, the system is further arranged to monitor the medical procedure and to detect whether user actions are erroneous with respect to a least one characteristic selected from the group consisting of time constraints, duration constraints, order constraints, sequence constraints, direction constraints, location constraints, target constraints, and combinations thereof. Particularly in time-critical protocols, when the user hesitates or makes an error which causes him/her to spend more time on an action than intended, the AR device may warn the user that it might be problematic to complete the full protocol in time. Hence, the AR device may recommend aborting the actual attempt to carry out medical procedure and to start the procedure all over again.

The following table elucidates an example of a respective medical procedure:

| action | object | target | last permissable time |
|---|---|---|---|
| action 1 | object A | target AA | 00′29″ |
| action 2 | object B | target BB | 00′57″ |
| action 3 | object C | target CC | 01′13″ |
| \| | \| | \| | \| |
| \| | \| | \| | \| |
| \| | \| | \| | \| |
| action n | object N | target NN | maximum total time |

The AR device may process respective software code/algorithms so as to guide the user through the procedure. The AR device is capable of instructing the user accordingly. Further, the AR device is arranged to monitor and control the execution of the (sub-)steps of the procedure.

In yet another exemplary embodiment of the system, the augmented reality device is adapted for outpatient treatment, wherein the medical procedure comprises a medical protocol that can be executed by an amateur user or by the patient itself. Since the user may to some extent rely on the system when executing the procedure, respective reservations regarding outpatient treatment may be further reduced. The system is capable of providing both positive feedback (step successfully accomplished) but also negative/corrective feedback (step needs to be re-performed due to an erroneous action). Further, the system may not only indicate that an error occurred but also explain what actually happened (e.g. time limit missed, wrong object used, deviation from the defined order of steps). The AR device is capable of detecting mistakes made by a user, i.e., the event of a “base marker” being masked with the incorrect “cover marker”. As a response, the AR device may provide AR-based live feedback on top of the “cover marker” that informs the patient immediately about the mistake and that guides the patient in correcting the mistake. Further, the AR device may verify the completion of a scene, i.e., the event of a “base marker” being masked with the correct “cover marker”. In this case a next state/step in the execution of the procedure may be triggered.

In yet another exemplary embodiment of the system, the medical procedure comprises a medical protocol comprising a series of steps each of which comprises at least one characteristic selected from the group consisting of a defined action, a defined object, a defined target, a defined duration, a defined permissible total time, and combinations thereof. By way of example, the field of application may involve blood analysis for chemotherapy patients. The field of application may further involve blood sugar measurement for diabetics. Both procedures require the execution of a plurality of steps that may involve disinfection, probing, sample collection, sample handling, treatment of the probing spot, putting the probe into analyzing means, etc.

In yet another exemplary embodiment, the system comprises at least one reference marker that can be detected by the augmented reality device, wherein the at least one reference marker indicates the medical procedure to be executed. Preferably, the at least one reference marker may also indicate defined positions of the at least one base marker and, more preferably, defined start positions of the at least one cover marker.

By way of example, a respective reference marker may be attached to or arranged at an outer packaging of a medical set to be used in the medical procedure. The reference marker and the base markers may be arranged at the same board or base element. The reference marker may serve different purposes. First, the reference marker may provide referential positional information that may facilitate detecting and monitoring the base markers. In other words, the reference marker may “tell” the AR device where the base markers should be located. The reference marker may define an overall orientation of the pad of base element that contains the base markers. Second, the reference marker may identify the to-be-applied medical routine or procedure. This may be beneficial since the AR device basically may be capable of guiding the user through different medical procedures. Accordingly, a pre-selection of the currently to-be-applied procedure may be beneficial. Consequently, the AR device may be referred to as a multi-purpose medical procedure user guidance AR device.

Given that the system may implement base markers, cover markers and reference markers, three different types of markers may be utilized. The system is arranged to verify that a user has placed a physical object at a specific spot. This mechanism may allow for a user interface that is free of physical or graphic user interface buttons for confirming the position of a physical object. Rather, confirmation of successful (sub-)steps and/or indications of erroneous (sub-)steps may be provided in the AR domain. Corrective action may be suggested also in the AR domain. When the reference marker is arranged to indicate the type of the medical procedure, no or only little (tactile) user inputs are required which is a huge advantage for many users, particularly for elderly or ill people.

In accordance with the above embodiment, the AR device may be arranged to detect the reference marker which may be a prerequisite for the initialization and execution of the medical procedure. It may be further required that the reference marker is always or at least temporarily “visible” for the sensor unit when possible matches (e.g., putting one on top of the other) of cover markers and respective base markers are sensed and detected. In this way, a safety level may be further enhanced. The risk of maloperations, misuse, etc. can be even further reduced. Preferably, the reference marker and the base markers are physically (e.g. mechanically) interconnected, e.g. placed on the same board or base element.

In accordance with at least some embodiments, the AR device is capable of detecting and monitoring three or more AR markers simultaneously. Hence, relatively complex operations that require handling a plurality of elements can be performed. Generally, the AR device may basically constantly or intermittently verify whether the reference marker that serves as a global reference is in sight. Preferably, the AR device is capable of simultaneously detecting an even greater number of markers. In this way, the system is sufficiently flexible to detect possible operations errors at an early stage and to provide early feedback, preferably before an irreversible error occurs that for instance “consumes” an object that then needs to be replaced or separately treated so as to be able to further proceed with the procedure.

In yet another exemplary embodiment, the system is further arranged to provide corrective user feedback to the user that involves in-protocol corrections in the course of the medical procedure. In-protocol corrections may particularly include an action selected from the group consisting of aborting and re-performing a step, completing and re-performing a step, returning and re-performing a series of steps, and completing a plurality of steps, in case of an error, returning to the starting point without accomplishing the medical procedure and re-performing the plurality of steps, and combinations thereof.

Consequently, the medical procedure quite often may be accomplished without the need to completely abort a prior attempt. Rather, in-process or in-protocol corrective actions enable to stay within the current medical procedure. This may have the advantage that excessive waste of (disposable and/or consumable) objects and time can be avoided. In case the complete medical procedure needs to be re-performed, due to an error, typically new (medical) objects should be utilized and consumed.

Generally, the system, particularly the AR device, may provide corrective feedback when objects are misplaced. This may involve an indication of directions and/or locations that are indicative of targets where to put the object in case it has been misplaced. Preferably, corrective feedback may be provided relative to the detected wrong location. Consequently, the AR device is capable of responding to an actual situation and providing situation-specific (contextual) corrective action. This may be achieved since the AR device is capable of (instantly) monitoring the markers. Therefore, corrective actions quite often can be smart and manageable since it is often not necessary to perform a fixed predefined corrective action (e.g. “go back to the previous step . . . ”) which might be problematic when the user is not totally aware of the current (handling) error.

Further, the AR device may provide corrective feedback when (sub-)steps of the medical procedure have been processed too slow, e.g. when a cover marker is placed at its corresponding base marker only after a predefined time limit expired. Hence, the system may be operable to provide time-monitoring. However, the AR device may be further arranged to indicate that time-related or duration-related errors may occur in due time before the actual time limit is exceeded. Consequently, the user may be encouraged to speed up the execution of the medical procedure and/or respective (sub-)steps. In case a total time-limit for the medical procedure is exceeded, the AR device may further indicate which (sub-)step should be performed quicker than in the erroneous attempt.

In other words, the guidance system in accordance with at least some embodiments disclosed herein is capable of providing contextual feedback on erroneous actions and of providing corresponding contextual guidance. Preferably, the guidance system is arranged to provide user guidance without the need (or with only little need) of explicit user input (at the level of the AR device). In other words, user “inputs” are preferably derived from the user's actual actions when executing the medical procedure. There is therefore no explicit requirement to manually tick off items in a check list since the guidance system automatically monitors and checks the completion of the steps. This is particularly beneficial in the medical field since the user may basically operate the AR device in the course of the procedure hands-free without the need of touch user inputs. This serves hygienic purposes and prevents mutual contamination of the AR device, the patient himself/herself and/or the objects to be used in the medical procedure.

To this end, the AR device detects correct positioning of a physical object when a specific “base marker” has been masked (or: covered) by another specific “cover marker”. In other words, in accordance with an aspect of the disclosure, a user interface is proposed that is basically free of physical or graphic user interface buttons for confirming the correct positioning of a real-world object and/or triggering the application to go to the next step of the procedure.

In a hand-held based AR application this basically enables hands-free interaction and therefore also solves hygiene issues of interacting with a touchscreen. In a head-worn based AR application the need for additional gesture or voice interaction for triggering/confirming readiness to go to the next step of the procedure may be overcome.

In another aspect of the present disclosure, a use of an augmented reality device in a system for user guidance in a medical procedure is presented, the augmented reality device comprising:
a display unit arranged to present artificial information that can be overlaid on an original scene,
a sensor unit,
a processing unit,

the system further comprising:
at least one first marker that can be detected by the augmented reality device, wherein the at least one first marker is associated with an object to be used in a defined step of the medical procedure, wherein the medical procedure comprises at least one step that requires a user action, particularly involving manually handling the object,

wherein the augmented reality device is operable to
monitor a scene and to detect and track the at least one first marker,
provide user guidance to execute the medical procedure,
detect whether user actions comply with the medical procedure, based on a detected state of the at least one first marker, and
when the augmented reality device detects an erroneous user action, provide corrective user feedback to the user.

In another exemplary embodiment of the use aspect, the use may comprise use of the augmented reality device in a hospital at home environment, wherein the hospital at home environment preferably comprises at least one specific use selected from the group consisting of home chemotherapy, home blood analysis, home blood sampling, home sample collection, home insulin therapy, home vaccination, and combinations thereof. Hospital at home may be regarded as a service that provides active treatment by health care professionals, in the patient's home, of a condition that otherwise would require acute hospital in-patient care, typically for a limited period.

In still another exemplary embodiment of the use aspect, the use may comprise use of the augmented reality device in a system for user guidance in an emergency treatment environment, particularly for an automated external defibrillator (AED) arrangement. While it is acknowledged that automatic or semi-automatic AED devices are commonly known, correct use of such a device is still considered a challenge for many people which may limit further distribution and, more particularly, application of AEDs. In case of an emergency, many peoples are still afraid of using AEDs. A system in accordance with at least some aspects of the present disclose may further reduce an inhibition level or even an aversion to using AEDs in cases of emergency since the system may guide the first aider and may support and back up the helping person. The system may ensure that the user utilizes the correct objects in the correct manner and the correct order while keeping required time constraints, for instance.

A further beneficial use of the system can be found in the filed of training or educating medical staff and/or laypersons. To this end, the system may be arranged to assist the user in practicing emergency cases to be prepared for real cases of emergency. Hence, the system may comprise a training mode in which the user is guided through a training situation to become familiar with medical equipment, such as AEDs and similar complex medical devices, without facing the risk of harming potential patients. Also in hospital-to-home environments as indicated above, training sessions including test runs may further enhance the user's capabilities.

In yet another aspect of the present disclosure, a method of providing augmented reality based user guidance for multi-step medical procedures is presented, the method comprising:
providing an augmented reality device comprising:
   a display unit arranged to present artificial information that can be overlaid on an original scene,
   a sensor unit,
   a processing unit, and
providing at least one first marker that can be detected by the augmented reality device, wherein the at least one first marker is associated with an object to be used in a defined step of the medical procedure, wherein the medical procedure comprises at least one step that requires a user action, particularly involving manually handling the object,
   monitoring a scene, detecting and tracking the at least one first marker,
   providing user guidance to execute the medical procedure,
   detecting whether user actions comply with the medical procedure, based on a detected state of the at least one first marker, and
   when the device detects an erroneous user action, providing corrective user feedback to the user.

In yet another aspect of the present invention, there is provided a computing device program comprising program code means for causing a computer to perform the steps of the above method when said computer program is carried out on the computing device.

As used herein, the term “computer” stands for a large variety of data processing devices. In other words, also medical devices and/or mobile devices having a considerable computing capacity can be referred to as computing device, even though they provide less processing power resources than standard desktop computers. Furthermore, the term “computer” may also refer to a distributed computing device which may involve or make use of computing capacity provided in a cloud environment. Preferably, the computer is implemented in or coupled to an AR device.

Preferred embodiments of the invention are defined in the dependent claims. It should be understood that the claimed uses, methods and the claimed computer program can have similar preferred embodiments as the claimed system and as defined in the dependent system claims.

### BRIEF DESCRIPTION OF THE DRAWINGS

These and other aspects of the invention will be apparent from and elucidated with reference to the embodiments described hereinafter. In the following drawings

FIG. 1 shows a front view of a portable hand held device that may be used as AR device in some embodiments of the present disclosure;

FIG. 2 shows a perspective view of a portable head-wearable device that may be used as AR device in some embodiments of the present disclosure;

FIG. 3 shows a schematic illustration of a general layout of an AR device in accordance with some embodiments of the present disclosure;

FIG. 4 shows a perspective view of an exemplary medical kit that may be used in an AR supported medical procedure in accordance with some embodiments of the present disclosure;

FIG. 5 shows a perspective view of an exemplary user guidance system in accordance with some embodiments of the present disclosure, the system implementing an AR device;

FIG. 6 shows a further state of the user guidance system illustrated in FIG. 5;

FIG. 7 shows yet a further state of the user guidance system illustrated in FIG. 5;

FIG. 8 shows an exemplary object to be used in a medical procedure;

FIG. 9 shows another exemplary object to be used in a medical procedure;

FIG. 10 shows yet another exemplary object to be used in a medical procedure;

FIG. 11 shows an arrangement of medical equipment comprising objects to be used in a medical procedure;

FIG. 12 shows a perspective view indicating an exemplary medical procedure which may be facilitated by an AR supported user guidance system;

FIG. 13 shows a schematic block diagram illustrating several steps of a procedure that relates to the arrangement of a medical kit that can be used in an AR supported environment;

FIG. 14 shows a schematic block diagram illustrating several steps of an exemplary user guidance method in accordance with the present disclosure; and

FIG. 15 shows an illustrative block diagram representing several exemplary steps of an AR supported monitoring and user guidance method in accordance with the present disclosure.

### DETAILED DESCRIPTION OF THE INVENTION

In recent years, augmented reality (AR) has made considerable progress and met several fields of application. By way of example, AR techniques may find application in on-street navigation for pedestrians. A user may look at a display of an AR device and perceive a live-presentation of the real-world environment that is enhanced by additional information augmented thereto.

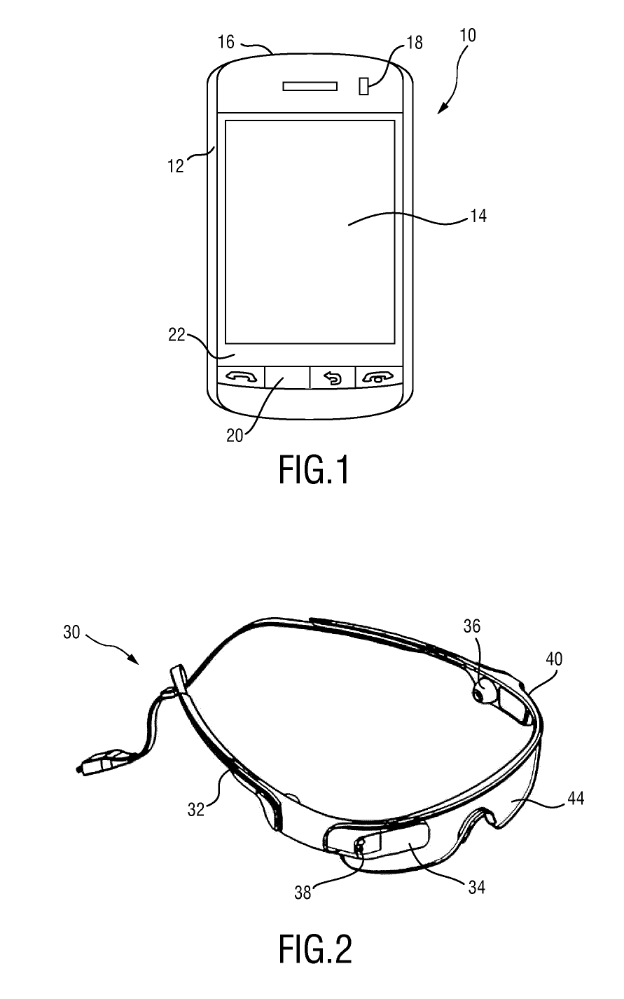

As indicated in FIGS. 1 and 2, different types of AR device can be envisaged. FIG. 1 shows a hand-held portable device 10 which may be arranged as a mobile device, particularly a mobile phone, a tablet computer, a smart phone, etc. FIG. 2 shows a head-mounted or head-mountable device 30. Both types, hand-held and head-mounted devices 10, 30 may allow for AR based applications that may be used in the medical field, particularly for guiding a user in the course of a medical procedure.

At least to some extent, hand-held type and head-mounted type devices 10, 30 are arranged in a similar manner. As can be seen in FIG. 1, the AR device 10 may comprise a housing 12 that houses a display unit 14, an audio output unit 16, a sensor unit 18 (in AR environments typically arranged at the opposite side of the display unit), an input unit 20, and a processing unit 22 (not explicitly shown in FIG. 1).

Similarly, the head-mounted 30 AR device illustrated in FIG. 2 comprises a frame or support 32 that supports a display unit 34, an audio output unit 36, a sensor unit 38, an input unit 40, and a processing unit 42 (not explicitly shown in FIG. 2). Further, a glass or visor 44 may be provided.

The sensor units 18, 38 may comprise at least one image sensor, particularly a camera sensor. At least in some embodiments, the sensor units 18, 38 may comprise wireless communication sensors, such as near field communication (NFC) sensors, electromagnetic sensors, such as Radio-frequency identification (RFID) sensors, etc. Also a combination of respective sensor types may be envisaged. The audio output units 16, 36 may comprise at least one audio speaker. The input units 20, 40 may comprise touch-sensitive or proximity sensitive sensor pads or surfaces. Consequently, the input unit 20 of the AR device 10 may be implemented in the display unit 14 thereof. The AR device 10 may comprise a touch-sensitive display 14. As can be seen in FIG. 2, the input unit 40 may be arranged separate from the display unit 34. Hence, the input unit 40 may comprise a distinct touch-sensitive pad or surface. The input units 20, 40 may further comprise discrete input elements, such as buttons, keys, etc. Further input elements may address gesture detection, speech recognition, etc.

The device 10 of FIG. 1 is arranged to represent a view of the real world scene that is captured by the sensor unit 18, particularly by a camera thereof. Consequently, the device 10 can be arranged to display a “copy” of the real-world environment sensed by the sensor unit 18 at the display unit 14. The representation can be overlaid with artificial (“augmented”) information to guide/navigate a user that is looking at the display unit 14 when executing a medical procedure.

By contrast, the device 40 of FIG. 2 may be arranged to enable a more or less “direct” view of the real world scene. Hence, it is not necessarily required that the display unit 34 displays a “copy” of the real world scene. Rather, the display unit 34 may be primarily utilized to display additional information that is virtually overlaid on the real world scene to guide/navigate the user through the medical procedure.

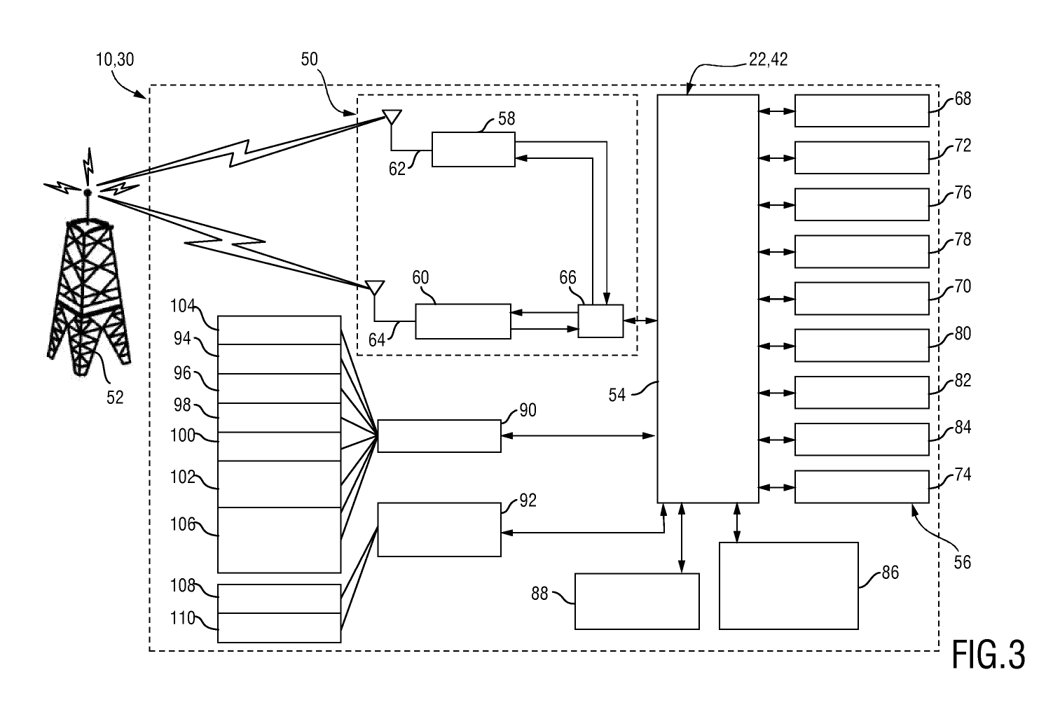

FIG. 3 schematically illustrates an exemplary arrangement of a hand-held appliance which can be arranged as an AR device 10, 30 in accordance with at least some embodiments of the present disclosure. Generally, FIG. 3 illustrates a block diagram of an exemplary electronic device, particularly a portable or wearable electronic device 10, 30 as shown in FIGS. 1 and 2, for instance. The following section is primarily provided for illustrated purposes and shall be therefore not understood in a limiting sense. It shall be therefore understood that in many embodiments within the scope of the present disclosure not each and every element or module illustrated in FIG. 3 has to be implemented.

As shown in FIG. 3, the device 10, 30 may include a processor unit 22, 42 comprising at least one microprocessor 54 that controls the operation of the electronic device 302. Further, a communication subsystem 50 may be provided that may perform communication transmission and reception with a wireless network 52.

The communication subsystem 50 may comprise a receiver 58 and a transmitter 60. The receiver 58 may be coupled to a receiving antenna 62. The transmitter 60 may be coupled with a transmitting antenna 64. Further, a digital signal processor 66 may be provided that acts as a processing module for the communication subsystem 50.

The processor unit 22, 42 further can be communicatively coupled with a number of components of the AR device 10, 30, such as an input/output (I/O) subsystem 56, for instance. The input/output (I/O) subsystem 56 may comprise or be coupled to a camera sensor 68, a display 70, further sensors 72, such as an accelerometer sensor, internal system memory 74, such as random access memory, standard communication ports 76, such as universal bus ports (USB ports), non-standard communication ports 78, such as proprietary ports, input elements 78, such as keyboards, (physical and virtual) buttons and/or touch sensitive elements, speakers 82, microphones 84, etc.

Apart from that, further subsystems may be present, such as additional communications subsystems 86, further device subsystems 88, etc. An example of a communication subsystem 86 is a short range wireless communication system and associated circuits and components. Examples of other device subsystems 88 may include additional sensors that may be used to implement further aspects of the present disclosure.

Generally, the processor 54 is able to perform operating system functions and enables execution of programs on the electronic device 10, 30. In some implementations not all of the above components are included in the electronic device 10, 30.

The processor unit 22, 42 may be further coupled with a non-volatile computer storage medium 90, such as flash memory, and with a subscriber identification module (SIM) interface 92, in case the device 10, 30 is arranged for mobile network or telephony services.

The storage medium 90 may contain permanently or temporarily stored data and applications, such as an operating system 94, a data and program management application 96, information on a device state 98, information on a service state 100, user contacts (address book) 102, further information 104, and a user guidance program/application 104 within the context of at least some embodiments disclosed herein.

The subscriber identification module (SIM) interface 92 may be coupled with a respective SIM card that may contain identification and subscriber related information 108 and further general (network) configuration data 110.

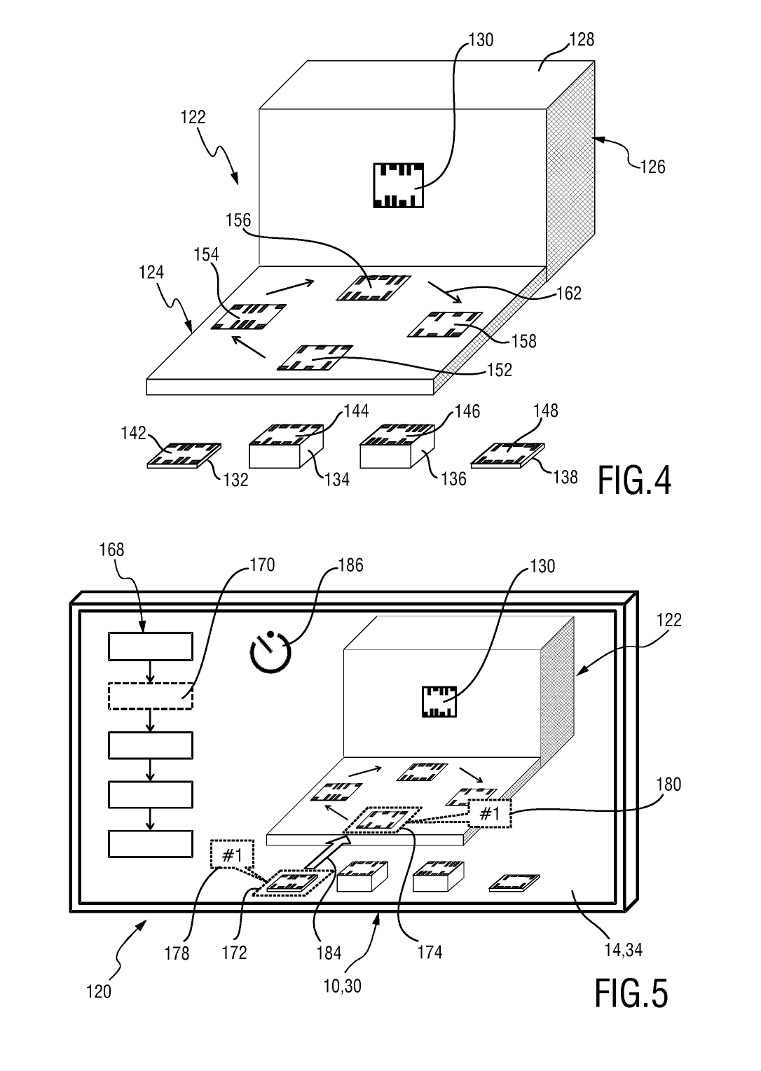

With further reference to FIGS. 4 to 7, a user guidance system 120 within the general concept of the present disclosure is illustrated and further explained. FIG. 4 illustrates an exemplary medical kit 122 which may be used (and at least partially consumed in some cases) in a medical procedure. The medical procedure generally includes a series of steps requiring defined user action(s) in a predefined order. In connection with an AR device 10, 30, the medical kit 122 may define a user guidance system 120, refer to FIGS. 5 to 7.

FIG. 4 illustrates a real-world view of the medical kit 122. FIGS. 5 to 7 illustrate an augmented view of the medical kit 122. In other words, in FIG. 4 a user may directly view at the medical kit 122. In FIGS. 5 to 7, a mediate view of the medical kit 122 overlaid by guidance information may be presented to the user of the device 10, 30. It is recalled in this respect that particularly the head-mounted AR device 30 of FIG. 2 is configured to enable a direct live view of the real-word scene. That is, in some embodiments only a representation of the additional augmented information is generated by the AR device 30 and overlaid on a “real” real-world scene.

By way of example, the medical kit 122 may be arranged as a blood sampling kit, for instance for chemotherapy patients. Furthermore, the medical kit 122 may be arranged as a blood sugar level measurement kit for diabetics. Generally, the medical kit 122 may take different forms and compositions that are adapted to different applications. As a further example, the medical kit 122 may be arranged as a pregnancy test kit.

The medical kit 122 may comprise a base, pad or board 124. Further, the medical kit 122 may comprise medical equipment 126 that may be coupled with or arranged at the base 124. By way of example, the medical equipment 126 may comprise a blood analyzer, a blood sugar meter, etc. Consequently, the medical kit 126 may enable relatively complex operations in the medical domain, particularly in an outpatient environment, for instance in an hospital at home environment. Of course, there may be further embodiments of the medical kit 122 that do not require an internal analyzing/measurement apparatus. By way of example, the medical equipment 126 may then comprise a sample preparation unit for the preparation of samples (e.g., blood samples) that may be sent to external sample analyzing services.

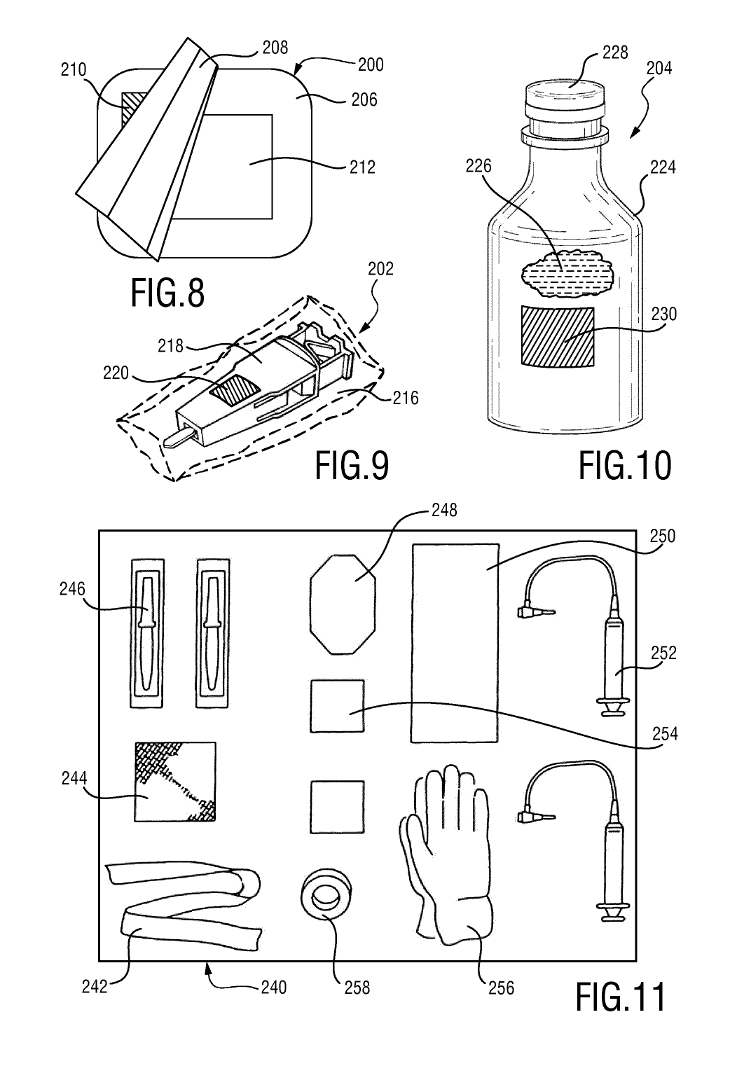

The medical kit 122 may comprise a housing or container 128 which may be arranged to house the medical equipment 126. Consequently, the medical kit 122 may be arranged as an integrated kit that comprises all or most of the objects that are required for the completion of the medical procedure. The medical kit 122 may be re-filled or supplemented with consumable material. As indicated above, the medical kit 122 typically comprises a number of objects 132, 134, 136, 138 which are represented in FIGS. 5 to 7 by respective blocks. The objects 132, 134, 136, 138 may comprise consumable objects, disposable objects and/or re-usable objects. At least some of the objects 132, 134, 136, 138 are equipped with so-called cover markers 142, 144, 146, 148. Examples of the objects 132, 134, 136, 138 are illustrated in FIGS. 8 to 11 further below.

At a defined position of the medical kit 122, a reference marker 130 may be provided that is recognizable by the AR device 10, 30. Furthermore, the medical kit 122, particularly the base 124 thereof, may be provided with a number of so-called base markers 152, 154, 156, 158 which may be affixed to the base 124.

The markers 130, 142-148, 152-158 may be generally referred to as AR markers or tags. The markers 130, 142-148, 152-158 may comprise coded data, e.g. one-dimensional or two-dimensional optical machine-readable patterns. Furthermore, the markers 130, 142-148, 152-158 may comprise digitally stored data, e.g. RFID data, NFC data, etc. that can be sensed by the sensor unit 18, 38.

The reference marker 130 may allow conclusions as to a reference position/orientation. Further, the reference marker 130 may indicate a type of the medical procedure. In this way, the reference marker 130 may actually trigger the correct application and protocol at the AR device 10, 30. More particularly, based on the detection of the reference marker, the AR device 10, 30 may derive defined positions (or: set positions) of the base markers 152, 154, 156, 158. This may facilitate and improve the accuracy of the detection of the base markers 152, 154, 156, 158. The indication of the type of procedure by the reference marker 130 may have the further advantage that the AR device 10, 30 can be used for different medical procedures.

The objects 132, 134, 136, 138 may be tagged or labeled with respective object markers or cover markers 142, 144, 146, 148. This may involve that the cover markers 142, 144, 146, 148 are arranged at the objects' packaging. Consequently, in the course of the execution of the medical procedure or protocol, each object 132, 134, 136, 138 can be identified by the device 10, 30 through the detection of its cover marker 142, 144, 146, 148. A main aspect of the present disclosure is the detection of matches between base markers 152, 154, 156, 158 and cover markers 142, 144, 146, 148. To this end, to accomplish a step of the multi-step procedure, the user is instructed to place the cover markers 142, 144, 146, 148 on top of their counterpart base markers 152, 154, 156, 158. This basically needs to be performed in a particular order. This may involve removing the cover marker 142, 144, 146, 148 from the object 132, 134, 136, 138 when the object is consumed. In the alternative, this may involve placing the object 132, 134, 136, 138 on top of the base markers 152, 154, 156, 158, whereas the cover marker 142, 144, 146, 148 is still affixed to the object 132, 134, 136, 138, e.g. for medical instruments.

The base markers 152, 154, 156, 158 may be arranged at the base 124 in a particular order or pattern, refer to the visual guide 162 that may be visible in the real-world environment. In other words, the base 124 may be arranged somewhat similar to a “play board” that provides real-world visual guidance. The visual guide 162 may comprise respective guide arrows.

In accordance with at least some embodiments discussed herein, the visual guide 162 is supplemented by artificial guidance information that is visible to the user when the user performs the medical procedure while viewing the scene on the display unit 14, 34. A respective virtually enhanced scene is illustrated in FIGS. 5 to 7 which contain an indirect view of the medical kit 122 illustrated in FIG. 4.

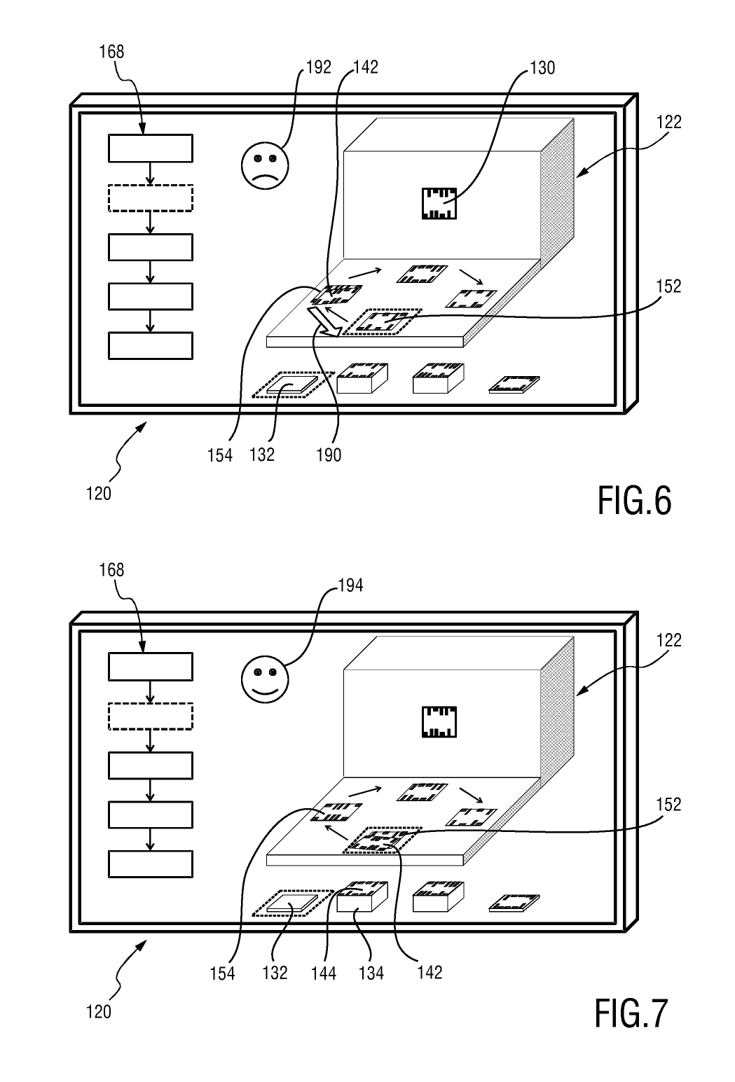

The user guidance system 120 combines the AR device 10, 30 and the medical kit 122 which is adapted to the AR supported user guidance approach. The AR device 10, 30 may be able to generate virtual information that can be overlaid on the real-world scene. The AR device 10, 30 is capable of guiding the user through a medical protocol, as indicated by the block diagram sequence 168 in FIGS. 5 to 7. Consequently, the user may always notice the current status or step of the to-be-processed medical procedure. The current step may be highlighted accordingly, refer to reference numeral 170 in FIG. 5. Further, the AR device 10, 30 may be arranged to detect and to highlight markers 142-148, 152-158 that are utilized in the procedure. For instance, given the current step 170 of the protocol 168, the AR device 10, 30 may monitor and track the markers 142-148, 152-158 that are within sight, and highlight the markers 142, 152 (refer to FIGS. 6 and 7) that have to be used at the current stage. The successfully detected pair of markers 142, 152 is indicated in FIG. 5 by reference numerals 172 (detected cover marker), 174 (detected base marker). The AR device 10, 30 may then (virtually) highlight the markers 172, 174 at the display unit 14, 34, refer to exemplary highlighting elements 178, 180 in FIG. 5.

The AR device 10, 30 may provide further information, e.g. an identifier for the markers 142, 152. Using AR techniques, the AR device 10, 30 may generate and display augmented visual guide elements, e.g. a guide arrow 184, as shown in FIG. 5. Hence, a navigation path or direction may be emphasized which facilitates positioning the detected cover marker 142 on top (or at least in the proximity of) its counterpart mating base marker 152. The risk of maloperations or operator errors can be greatly reduced in this way. Even if the user is not a well-training expert, the medical procedure can be successfully accomplished with relatively little efforts.

The medical procedure or at least one (sub-)step thereof may be subject to time constraints. The AR device 10, 30 may be therefore further configured to track the time or duration of the user's actions, refer to the exemplary time symbol 186 in FIG. 5. Hence, the AR device may indicate that a step may be accomplished in due time, or that a step is in a time-critical stage. In case a time limit is missed, the user may be informed accordingly, the AR device 10, 30 may abort the current step of the procedure. Before the time limit is about to be reached, the AR device 10, 30 may inform and encourage the user accordingly to fulfill the time-critical action in due time.

Generally, the user guidance system 120 may be further arranged to provide corrective user guidance in case an operating error or at least a potentially upcoming or an imminent operating error is detected. A respective situation is illustrated in FIGS. 6 and 7. The AR device 10, 30 is capable of detecting situations when the user picks or moves the wrong object 132, 134, 136, 138 which is not required to accomplish the current (sub-)step 170. Further, the AR device 10, 30 is capable of detecting situations when the user misplaces the cover marker 142, 144, 146, 148. Hence, the AR device 10, 30 may provide error feedback 192 which catches the user's attention, refer to FIG. 6. In FIG. 6, the user mistakenly placed the cover marker 132 on top of the base marker 154, rather than on its intended counterpart 152. The erroneous handling can be detected. Accordingly, corrective guidance 190 may be provided. Corrective guidance 190 may include indicating the correct object 132, 134, 136, 138 by highlighting its cover marker 142, 144, 146, 148. Corrective guidance may also include navigating to user to the correct base marker 152 that matches the currently used cover marker 142, as indicated in FIG. 6 by a respective guide arrow 190. When the user is able to rectify the mistake, the AR device 10, 30 may provide positive feedback so as to indicate that the user is back on track in the execution of the medical procedure. Accordingly, the AR derive 10, 30 may proceed with the next (sub)step, e.g. handling the next object 134 and its corresponding markers 144, 154.

With particular reference to FIGS. 8 to 10, several objects that may be used in medical procedures and that may be tagged or labeled with respective markers are illustrated. FIG. 8 shows an exemplary disposable object 200, which may be arranged as an alcohol swab, a plaster, and suchlike, that may be shaped as a pad 212. FIG. 9 shows another exemplary disposable object 202, which may be arranged as a lancet, e.g. for collecting blood samples. Another exemplary object 204 which is arranged as a vial is shown in FIG. 10. The object 200 of FIG. 8 comprises a disposable packaging 206 which may comprise a cover or lid 208. The object 200, particularly the packaging 206 thereof, may be tagged or labeled with a cover marker 210 that can be detected and tracked by the AR device 10, 30 as illustrated in FIGS. 4 to 7. Consequently, the user may unpack the object 200 and use the pad 212 in a (sub-)step of the medical procedure. To confirm and accomplish the execution of the (sub-)step, the user places the cover marker 210 at a respective base marker (not shown in FIG. 8) which can be detected by the AR device 10, 30.

Also the object 202 of FIG. 9 may be disposable. The lancet-like object 202 may comprise a disposable packaging 216 that seals and contains a lancet 218. By way of example, the cover marker 220 that identifies the lancet 218 may be directly attached the lancet 218. Consequently, the user may be instructed to place to lancet 218 on top of the corresponding base marker so as to indicate the completion of a (sub-)step of the procedure. As shown in FIG. 10, the object 204 may be arranged as a vial. The object 204 may comprise a bottle or flacon like housing 224 that may contain a substance 226 that is to be used in the course of the medical procedure. In the alternative, the object 204 may be used to contain sample material obtained in the course of the medical procedure. The bottle-like housing 224 may comprise a lid or cap 228. At the housing 224, or at the cap 228, a cover marker 230 may be arranged that allows for detecting and tracking the object 204 with the AR device 10, 30.

Further reference is made to FIG. 11, which illustrates an exemplary set of medical equipment 240. The set 240 may comprise materials, substances, instruments, and suchlike that may be used for/in medical procedures. The set 240 may be arranged as a multifunctional set which is set up for more than one type of medical procedure. Further, the set 240 may be arranged for repetitive execution of medical procedures, e.g. re-usable equipment or a plurality of consumable equipment and a sufficient amount of substances may be provided. For instance, the set 240 may comprise at least one tourniquet 242, at least one gauze 244, at least one catheter 246, at least one dressing/bandage 248, a padded arm board, at least one syringe 252, at least one alcohol swab 254, gloves 256, tape 258, components thereof, and respective replacement material. Each of the elements 242-258 may be tagged or labeled accordingly with an AR marker.

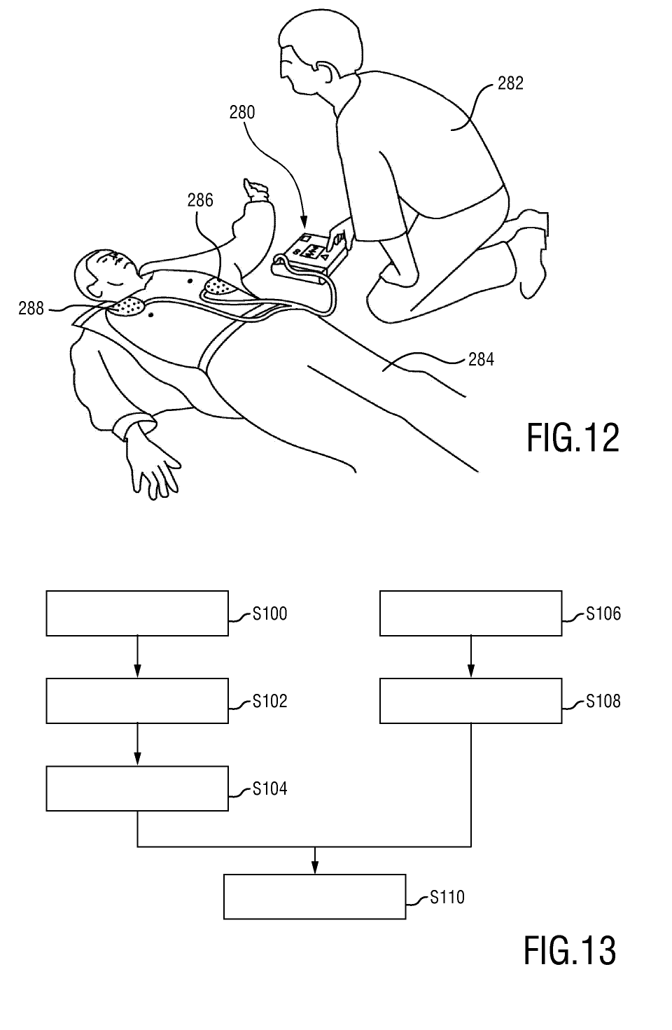

FIG. 12 exemplifies a further field of application for user guidance systems within the scope of the present disclosure. FIG. 12 shows an emergency situation wherein an automated external defibrillator (AED) 280 needs to be used. For instance, a patient 284 may suffer from cardiac dysrhythmia. Regrettably, well-trained (medical) professionals are typically not within reach in emergency cases. Typically, first aiders 282 are rather inexperienced. While it is acknowledged that particularly automated external defibrillators 280 are easy to use in standard training situations, emergency cases are often much more troublesome. Typically, the first aider 282 is under huge pressure. Consequently, an AR based user guidance system may back up the first aider 282 and facilitate the correct handling of the automated external defibrillator 280, which may involve activating the automated external defibrillator 280, placing electrodes 286, 288 at the patient 284 and—at least to some extent—controlling the operation of the automated external defibrillator 280. Consequently, also the automated external defibrillator 280 may form part of a user guidance system. To this end, respective cover markers and base markers may be affixed thereto, particularly to the electrodes 286, 288 and the AED's housing. Further, a reference marker may be provided that triggers and initializes a respective program at the AR device 10, 30 (refer to FIGS. 1 and 2) the user is using in the emergency medical procedure.

Having demonstrated several alternative exemplary approaches covered by the present disclosure, FIG. 13 is referred to, schematically illustrating a method relating to the arrangement of a medical kit that can be used in an AR supported environment in accordance with at least some aspects of the present disclosure. The method comprises a step S100 that involves providing a base, particularly a base sheet, base pad, base board, etc. The base is arranged as a base layer to which AR markers can be attached. The AR markers can be detected and traced/tracked by an AR device. By way of example, a so-called reference marker may be attached to the base layer in a step S102. The reference marker may provide a positional reference, which may facilitate and improve the detection of further markers that may be attached to the base layer. Having detected the reference marker, the AR device may derive (pre-)defined positions where the respective further markers are supposed to be placed. This may simplify the simultaneous detection of multiple markers. Further, the reference marker can be indicative of a type of medical procedure the to-be-prepared medical kit is arranged for.

In a further step S104, a plurality of base marker may be arranged at the base layer. Preferably, the base markers are arranged in a particular pattern and/or order so as to reflect the course or sequence of the intended medical procedure. The base markers may be detectable for the AR device, particularly for a sensor unit thereof. The base markers may represent goals where the user may place corresponding cover markers to accomplish a step of the intended medical procedure. Consequently, the AR device may detect on overlap between the base marker and the cover marker. This event may be indicative of the completion of the respective (sub-)step.

The equipped base layer may be regarded as a real-world representation of a sequence of actions of which the medical procedure is composed. However, since the base layer is equipped with AR markers, the AR device may detect and track the layers and provide supplemental virtual information to be overlaid on the real-world scene on a respective display.

A further step S106 may comprise providing a plurality of medical objects that are arranged to be used or consumed in the course of the execution of the medical procedure. For instance, the objects may comprise instruments, substances, consumable, disposable items, etc. The objects are typically manually handled by the user, at least in part. With respect to their medical effects and features, the objects may resemble conventional medical objects.

However, in a further step S108, AR markers may be attached to the objects. Attaching the AR markers may involve directly attaching the AR markers to the objects and/or attaching the AR markers to the object's packaging. The AR markers that are processed in step S108 may be referred to as cover markers, at least in some embodiments. The objects may be labeled or tagged with the AR markers. The cover markers may be detected and tracked/traced by the AR device. The AR device may be particularly suited to detect when a cover marker is brought into close proximity with a base marker, preferably when the cover marker covers (hides) the base marker. This may occur when the cover marker is placed on top of the base marker. In yet another step S110 of the method, the equipped medical objects and the equipped base layer are combined, e.g. as a medical kit in a common packaging unit. Hence, a medical kit may be provided that may be basically processed in a real-world environment that is not enhanced with virtual (artificial) information. However, the medical kit is also arranged to be used in AR enhanced environments since the respective (machine-readable) markers, at least the base markers and the cover markers, are provided. Preferably, also a reference marker is provided.

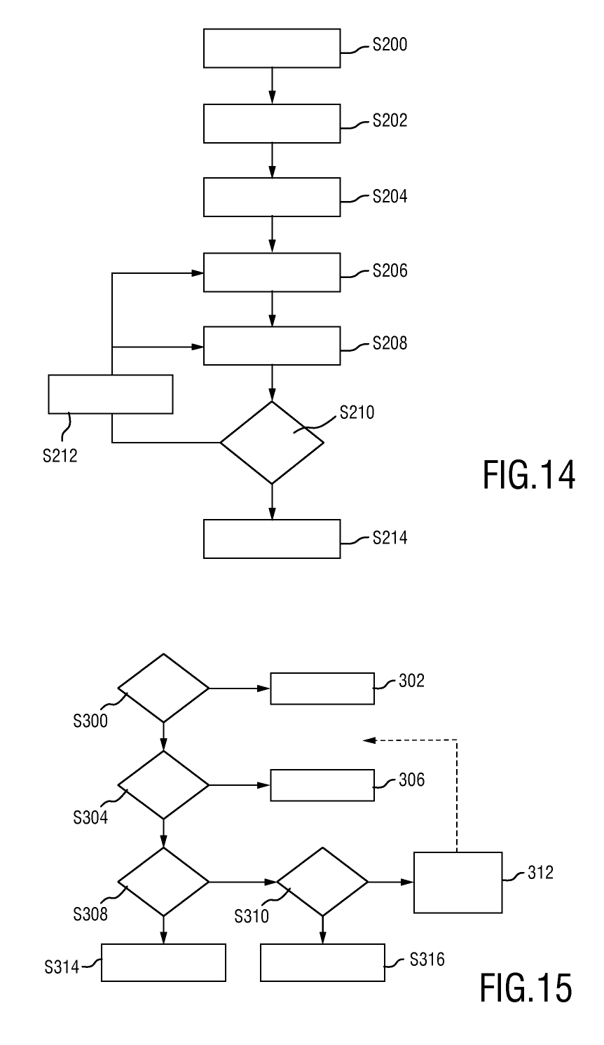

Further reference is made to FIG. 14 showing a schematic block diagram illustrating several steps of a user guidance method in accordance with the present disclosure. Initially, in a step S200, a portable augmented reality device within the context of the present disclosure may be provided that is equipped for AR applications in the medical field, particularly for AR supported user guidance applications to guide non-professional users, particularly the patients themselves, through relatively complex medical procedures. To this end, the AR device may be provided with respective components, e.g. at least one (image) sensor, a display, and a processing unit. Further, the AR device may comprise permanent and temporary memory comprising respective software code (software applications, or apps). Additionally, the AR device can make use of software code provided at a remote location, e.g. in a cloud environment. The software code may further comprise algorithms that describe the medical procedures or protocols the AR device is equipped for.

A further step S202 may follow which may include providing a medical kit that is arranged for AR supported user guidance. As explained above in connection with the method illustrated in FIG. 13, the medical kit may comprise a plurality of AR makers (also referred to as AR tags or AR labels) that can be detected an tracked by the AR device. There may be several types of AR markers. For instance, so-called base markers and cover markers may be provided. The cover markers may be associated with, particularly attached to, objects of the medical that have to be utilized, particularly manually handled or moved, when executing the medical procedure. The base markers may be arranged in a predefined pattern or order that may reflect several steps of the medical procedure. The user may generate a checkback signal by placing the cover markers close to, preferably on top of, their designated counterpart base markers. The AR device may be capable of detecting a respective match which indicates that a (sub-)step of the medical procedure has been successfully accomplished.

Preferably, the medical kit further comprises a reference marker that may be arranged in a basically predefined relative position with respect to the base markers. In a subsequent step S204, the AR device may detect the reference marker. The reference marker may be indicative of the type of the planned medical procedure. Hence, the correct corresponding (software) algorithm at the AR device may be triggered or selected. Preferably, no explicit user input or only little user input is required to this end. Further, the reference marker may be indicative of (or allow conclusions as to) expected positions of the base markers that from target positions to which the cover markers will be placed when executing the medical procedure.

A further step S206 may follow that includes providing AR supplemented user guidance to execute the medical procedure. The step S206 may comprise detecting and tracking the markers, and highlighting currently to-be-processed markers and their counterparts. Furthermore, user guidance may involve navigating the user to place the cover markers on top of their paired base markers while complying with the desired order/sequence.

In a monitoring step S208 that may be interrelated with the step S206, the AR device may monitor the scene so as to monitor and control the user's activities based on the detected markers and the way they are handled and/or brought into alignment. The AR device may be further equipped to detect defective user actions or at least potentially defective user actions (e.g. deviating from the desired order of the medical procedure, placing the cover marker on top of the wrong base marker, etc.). Furthermore, the AR device may be arranged for time tracking so as to control and verify whether the user is able to accomplish the required actions within given time constraints.

A further step S210 is indicated by a decision diamond. The decision step S210 may include a decision as to whether or not the user successfully accomplished a (sub-) step of the medical procedure. In case defective or potentially error-prone user actions are detected, the AR device may provide corrective feedback, refer to step S212. Corrective feedback may involve informing the user that an error occurred and highlighting potential remedies to bring the user back on course. Preferably, instant or quasi-instant in-process feedback may be provided which may avoid a repetition of the whole medical procedure. Corrective feedback may include highlighting correct goals for the currently handled cover markers, highlighting the correct cover marker that is to be used in the current (sub-)step, indicating time constraints and encourage the user to execute the procedure at a faster pace, etc.

The method may proceed to a further step S214 when it is detected that the user successfully accomplished respective (sub-)steps of the procedure. In case the user successfully accomplished each step of the procedure, the method may terminate at S214.

With reference to FIG. 15, another illustrative block diagram representing several steps of an AR supported monitoring and user guidance method in accordance with the present disclosure is shown. More specifically, FIG. 15 illustrates a monitoring and guidance algorithm that may be implemented in an AR device, as explained above. In an initial step S300 which may be arranged as a decision step, it may be verified whether a reference marker is detected, e.g. is in sight of a sensor of the AR device. In case no reference marker is detectable, a step S302 may follow in which the AR device continues looking for or seeking a reference marker. As already indicated above, the reference marker may actually trigger the execution of the medical procedure, and may be further indicative of an initial setup of a medical kit that is utilized in the medical procedure. In other words, the AR device may be provided with information on required steps of the medical procedure and corresponding objects including their cover markers and the associated base markers. Therefore, the AR device may become aware of defined positions of the base markers and of their intended order.

In case a reference marker is detected, the algorithm may proceed to a step S304, which may include a check as to whether a base marker is in sight. Step S304 may be focused on the base marker that is associated with the correct (sub-)step of the medical procedure. The exemplary embodiment of the algorithm illustrated in FIG. 15 uses a match of corresponding base markers and cover markers to verify that a particular (sub-)step has been accomplished. This may involve that the cover maker is placed on top of the base marker such that the base marker is basically no longer visible to the AR device's sensor unit. Conversely, in case the base marker is still within sight of the sensor unit, the (sub-)step has not been accomplished yet. Hence, the algorithm may proceed to a step S306, which may include look for and detection of the currently to-be-processed cover marker. The system may therefore also detect a cover marker that actually approaches its counterpart base marker.

In case a base marker of interest marker is not or no longer within sight, the algorithm may proceed to a step S308 which includes a detection of whether the correct cover marker has been placed on top of the base marker. If his is the case, there is a strong indication that the current (sub-)step has been successfully accomplished. The algorithm may proceed to step S314 which may include a termination of the algorithm or the execution of a further (sub-)step of the medical procedure in accordance with the algorithm of FIG. 15.

In case it is determined that the desired cover marker has not been successfully detected in step S308, the algorithm may proceed to a step S310 which includes a determination as to whether another wrong cover marker can be detected on top of the base marker. In this is the case, the algorithm may proceed to a step S316 and provide corrective feedback indicating that apparently the wrong object to which the wrong cover marker is attached has been used. In the alternative, in case no cover marker at all can be detected and identified as covering the base marker in step S310, the algorithm may proceed to a step S312 and provide feedback that apparently an unrecognizable object has been placed on top of the base marker.

In the following, further characteristics and benefits of exemplary embodiments within the scope of the present disclosure will be presented and explained.

In one embodiment, a system is provided that comprises augmented reality markers that placed in a physical context, and may be arranged to indicate target positions, where movable objects should end up in the course of a to-be-executed medical procedure. To this end, augmented reality markers may be placed on movable physical objects. An AR device comprising a display unit is provided, e.g. a smartphone, a tablet or an augmented reality headset. A protocol may be defined which specifies which movable object should go where and in what order. The AR device may be arranged to provide feedback when objects are misplaced. Particularly, the AR device may be arranged to provide navigation feedback or route indicating feedback with respect to locations where to put object in case it has been misplaced, relative to the wrong location, so as to enable in-protocol corrections. Further, the AR device may be arranged to provide feedback when handling and/or placement of objects is conducted too slow to meet the deadline for completing the total protocol. If a user is too slow, an indication may be provided with respect to which step should be executed quicker next time.

At least some embodiments may include tracking the position and orientation of the movable physical objects in a 2D or 3D space. In case an actually detected situation differs from the one specified by the protocol, it can be directly shown in the scene by means of augmented reality what is wrong and how to rectify the situation. By way of example, when the user is handling object B instead of object A, at a specified time or step to which object A is assigned, the AR device may indicate (e.g., at the display unit) that object B is being handled whereas the user should be handling object A instead. Similarly, when the user puts down object B instead of object A at a location to which object A is assigned, the AR device may indicate that hat object B is the wrong object, that the object of interest at the moment is object A instead, and that object B should be placed at a specific goal position that is assigned with object B. Further, when the user exceeds time limits (last permissible time) for a certain step, the AR device may indicate that the total procedure can no longer be completed in time, and encourage the user to speed up.

One field of application in the hospital-at-home domain may be blood analysis for chemotherapy patients, particularly for respective outpatients. Correspondingly, a medical kit or medical equipment may be provided that comprises a blood analyzer. A blood analyzer is a device which allows patients who are undergoing chemotherapy or similar therapies to test their blood at home. A respective blood testing procedure (also referred to as medical procedure herein) may comprise a protocol that includes a number of actions which must be executed in a particular order. By way of example, respective (sub-)steps may comprise:
warming up the patient's hand,
disinfecting the skin,
lancing a finger,
putting a drop of blood into a cartridge,
inserting the cartridge into the blood analysis device, and
putting a band-aid on the finger.

Consequently, the execution of the protocol requires a plurality of consumables (lancets, alcohol swabs, blood cartridges, band-aids). Further, the protocol is basically time critical: between lancing and putting the cartridge with blood into the blood analyzer, there should be no more than 45 seconds, for instance. If the user does not comply with this deadline, may be the total protocol needs to be executed again. This may cause discomfort (lancing again), wasted time and also waste of material (new disposable needle, new disposable alcohol swab, new blood cartridge). It is therefore important to guide the user as best as possible through the protocol, and through similar medical procedures.

Another field of application may be in the emergency care domain. As already indicated above, a system in accordance with at least some embodiments disclosed herein may be utilized in connection with automatic external defibrillator units (AEDs). AEDs are used in emergency care to stop a heart from fibrillating and ensure that all heart muscles contract in sync again. When using AEDs, a plurality of elements is used each of which needs to be placed correctly (in terms of order, position, etc.). These elements and objects may be arranged as electrode patches, for instance. A respective medical procedure must be strictly adhered to. Basically the same applies to the underlying protocol for resuscitation. The application of AEDs is particularly time critical. Hence, also AED and related or similar medical procedures in the emergency care domain could benefit from augmented reality guidance, which may be provided by a system in accordance with at least some embodiments disclosed herein.

In the claims, the word “comprising” does not exclude other elements or steps, and the indefinite article “a” or “an” does not exclude a plurality. A single element or other unit may fulfill the functions of several items recited in the claims. The mere fact that certain measures are recited in mutually different dependent claims does not indicate that a combination of these measures cannot be used to advantage.

A computer program may be stored/distributed on a suitable (non-transitory) medium, such as an optical storage medium or a solid-state medium supplied together with or as part of other hardware, but may also be distributed in other forms, such as via the Internet or other wired or wireless telecommunication systems. Furthermore, the different embodiments can take the form of a computer program product accessible from a computer usable or computer readable medium providing program code for use by or in connection with a computer or any device or system that executes instructions. For the purposes of this disclosure, a computer usable or computer readable medium can generally be any tangible apparatus that can contain, store, communicate, propagate, or transport the program for use by or in connection with the instruction execution device.

Furthermore, the different embodiments can take the form of a computer program product accessible from a computer usable or computer readable medium providing program code for use by or in connection with a computer or any device or system that executes instructions. For the purposes of this disclosure, a computer usable or computer readable medium can generally be any tangible device or apparatus that can contain, store, communicate, propagate, or transport the program for use by or in connection with the instruction execution device.

In so far as embodiments of the disclosure have been described as being implemented, at least in part, by software-controlled data processing devices, it will be appreciated that the non-transitory machine-readable medium carrying such software, such as an optical disk, a magnetic disk, semiconductor memory or the like, is also considered to represent an embodiment of the present disclosure.

The computer usable or computer readable medium can be, for example, without limitation, an electronic, magnetic, optical, electromagnetic, infrared, or semiconductor system, or a propagation medium. Non-limiting examples of a computer readable medium include a semiconductor or solid state memory, magnetic tape, a removable computer diskette, a random access memory (RAM), a read-only memory (ROM), a rigid magnetic disk, and an optical disk. Optical disks may include compact disk-read only memory (CD-ROM), compact disk-read/write (CD-R/W), and DVD.

Further, a computer usable or computer readable medium may contain or store a computer readable or usable program code such that when the computer readable or usable program code is executed on a computer, the execution of this computer readable or usable program code causes the computer to transmit another computer readable or usable program code over a communications link. This communications link may use a medium that is, for example, without limitation, physical or wireless.

A data processing system or device suitable for storing and/or executing computer readable or computer usable program code will include one or more processors coupled directly or indirectly to memory elements through a communications fabric, such as a system bus. The memory elements may include local memory employed during actual execution of the program code, bulk storage, and cache memories, which provide temporary storage of at least some computer readable or computer usable program code to reduce the number of times code may be retrieved from bulk storage during execution of the code.

Input/output, or I/O devices, can be coupled to the system either directly or through intervening I/O controllers. These devices may include, for example, without limitation, keyboards, touch screen displays, and pointing devices. Different communications adapters may also be coupled to the system to enable the data processing system to become coupled to other data processing systems, remote printers, or storage devices through intervening private or public networks. Non-limiting examples are modems and network adapters and are just a few of the currently available types of communications adapters.

The description of the different illustrative embodiments has been presented for purposes of illustration and description and is not intended to be exhaustive or limited to the embodiments in the form disclosed. Many modifications and variations will be apparent to those of ordinary skill in the art. Further, different illustrative embodiments may provide different advantages as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated. Other variations to the disclosed embodiments can be understood and effected by those skilled in the art in practicing the claimed invention, from a study of the drawings, the disclosure, and the appended claims.

Any reference signs in the claims should not be construed as limiting the scope.

1. An augmented reality based user guidance system for multi-step medical procedures, the system comprising:
an augmented reality device comprising:
a display unit arranged to present artificial information that can be overlaid on an original scene,
a sensor unit,
a processing unit,
at least one first marker that can be detected by the augmented reality device, wherein the at least one first marker is associated with an object to be used in a defined step of the medical procedure, wherein the medical procedure comprises at least one step that requires a user action, particularly involving manually handling the object,
wherein the augmented reality device is arranged to
monitor a scene and to detect and track the at least one first marker,
provide user guidance to execute the medical procedure,
detect whether user actions comply with the medical procedure, based on a detected state of the at least one first marker, and
when the augmented reality device detects an erroneous user action, provide corrective user feedback to the user.

2. The system as claimed in claim 1,
wherein a least one second marker is provided that is arranged at a location assigned to a defined step of the medical procedure, wherein the medical procedure comprises at least one step that requires placing the object, particularly the at least one first marker thereof, in the vicinity of the second marker to accomplish a step of the medical procedure.

3. The system as claimed in claim 2,
wherein the at least one first marker is arranged as a cover marker,
wherein the at least one second marker is arranged as a base marker, and
wherein the at least one first marker is attached to a disposable object or a consumable object, particularly to a packing or to a tamper-proof element thereof.

4. The system as claimed in claim 3,
wherein the at least one first marker is a non-stationary marker that is attached to an object that is to be moved in the course of the medical procedure,
wherein the at least one second marker is a stationary marker that indicates a characteristic location at medical equipment that is subject of the medical procedure, and
wherein the system is capable of detecting a state in which at least one non-stationary marker approaches a respective stationary marker to fulfil a step of the medical procedure.

5. The system as claimed in claim 1,
wherein the augmented reality device is arranged to indicate a subsequent step by virtually highlighting at least one marker associated with the subsequent step.

6. The system as claimed in claim 1,
wherein the system is further arranged to monitor the medical procedure and to detect whether user actions are erroneous with respect to a least one characteristic selected from the group consisting of:
time constraints, duration constraints, order constraints, sequence constraints, direction constraints, location constraints, target constraints, and combinations thereof.

7. The system as claimed in claim 1,
wherein the augmented reality device is adapted for outpatient treatment, and
wherein the medical procedure comprises a medical protocol that can be executed by an amateur user or by the patient itself.

8. The system as claimed in claim 1,
wherein the medical procedure comprises a medical protocol comprising a series of steps each of which comprises at least one characteristic selected from the group consisting of a defined action, a defined object, a defined target, a defined duration, a defined permissible total time, and combinations thereof.

9. The system as claimed in claim 1,
wherein the system comprises at least one reference marker that can be detected by the augmented reality device, wherein the at least one reference marker indicates the medical procedure to be executed.

10. The system as claimed in claim 1,
wherein the system is further arranged to provide corrective user feedback to the user that involves in-protocol corrections in the course of the medical procedure,
wherein in-protocol corrections may particularly include an action selected from the group consisting of
aborting and re-performing a step,
completing and re-performing a step,
returning and re-performing a series of steps, and completing a plurality of steps,
in case of an error, returning to the starting point without accomplishing the medical procedure and re-performing the plurality of steps, and
combinations thereof.

11. A use of an augmented reality device in a system for user guidance in a medical procedure, the augmented reality device comprising:
a display unit arranged to present artificial information that can be overlaid on an original scene,
a sensor unit,
a processing unit,
the system further comprising:
at least one first marker that can be detected by the augmented reality device, wherein the at least one first marker is associated with an object to be used in a defined step of the medical procedure, wherein the medical procedure comprises at least one step that requires a user action, particularly involving manually handling the object,
wherein the augmented reality device is operable to
monitor a scene and to detect and track the at least one first marker,
provide user guidance to execute the medical procedure,
detect whether user actions comply with the medical procedure, based on a detected state of the at least one first marker, and
when the augmented reality device detects an erroneous user action, provide corrective user feedback to the user.

12. The use as claimed in claim 11, comprising use of the augmented reality device in a hospital at home environment, wherein the hospital at home environment preferably comprises at least one specific use selected from the group consisting of home chemotherapy, home blood analysis, home blood sampling, home sample collection, home insulin therapy, home vaccination, and combinations thereof.

13. The use as claimed in claim 11, comprising use of the augmented reality device in a system for user guidance in an emergency treatment environment, particularly for an automated external defibrillator arrangement.

14. A method of providing augmented reality based user guidance for multi-step medical procedures, the method comprising:
providing an augmented reality device comprising:
a display unit arranged to present artificial information that can be overlaid on an original scene,
a sensor unit,
a processing unit, and
providing at least one first marker that can be detected by the augmented reality device, wherein the at least one first marker is associated with an object to be used in a defined step of the medical procedure, wherein the medical procedure comprises at least one step that requires a user action, particularly involving manually handling the object,
monitoring a scene, detecting and tracking the at least one first marker,
providing user guidance to execute the medical procedure,
detecting whether user actions comply with the medical procedure, based on a detected state of the at least one first marker, and
when the augmented reality device detects an erroneous user action, providing corrective user feedback to the user.

15. Computer program comprising program code means for causing a computing device to carry out the steps of the method as claimed in claim 14 when said computer program is carried out on a computing device.
